(19) United States
(12) Patent Application Publication
(10) Pub. No.: US 2005/0140224 A1
(43) Pub. Date: Jun. 30, 2005

(54) Electrical drive unit

(76) Inventors: Thomas Weigold, Baden-Baden (DE); Johannes Moosmann, Tennenbronn (DE)

Correspondence Address: Striker Striker & Stenby, 103 East Neck Road, Huntington, NY, 11743, US

(21) Appl. No.: 10/513,184

(22) PCT Filed: Feb. 2, 2004
(86) PCT No.: PCT/DE04/00155

(30) Foreign Application Priority Data
Mar. 25, 2003 (DE) 10313226.0

(51) Int. Cl. H02K 7/10; H02K 7/06; H02K 5/16

(52) U.S. Cl. 310/90; 310/83; 310/75 R; 74/606 R; 15/250.32; 384/140

(57) ABSTRACT

In a known electric drive unit, in particular for windshield wipers of a motor vehicle, with a drive motor that has a transmission housing (5) for containing at least one worm gear (9) that is supported on a driven shaft (7) and engages with a worm (13) connected to an armature shaft (11) of the drive motor, which driven shaft (7) is supported in an eccentric bush that can be rotated in order to adjust an axial distance (a) between the armature shaft (11) and the driven shaft (7) and can be mounted in the rotated position so that it is prevented from rotating in the transmission housing (5). The invention proposes that two eccentric bushes (19, 23) be mounted spaced apart from each other in the transmission housing (5) in order to support the driven shaft (7).

The current invention relates to an electrical drive unit according to the preamble to claim 1 and a method for mounting the drive unit.

It is generally known that drive units for windshield wipers in motor vehicles typically have a worm gear pair. In these drive units, it is necessary to adjust the axial distance between the worm axis and the worm gear axis as a function of the tolerances of the components used and as a function of manufacturing tolerances so as to minimize the tooth flank play. The adjustment is frequently executed by means of an eccentric bush that is installed in an appropriately prepositioned manner. The bearing length or the length of the eccentric bush, which is typically embodied as a sintered bush, is limited by the geometry of the bush and by the manufacturing process. The bushes produced according to the prior art have already reached the limits of produceability. At this time, eccentric bushes of up to a length of approx. 40 mm can be produced. Due to its length, the production of the bush is complex and therefore expensive and in addition, long eccentric bushes are associated with quality problems. It is also complex to produce the bearing seat for such long bushes.

A drive unit of this generic type, especially for windshield wipers of a motor vehicle, is known from DE 198 21 079 in which the driven shaft is supported in an eccentric bush. This eccentric bush can be rotated in order to adjust the axial distance between the armature shaft and the driven shaft and when in the rotated state, can be mounted on the transmission housing so that it is prevented from rotating. In order to assure a simple and inexpensive produceability, the eccentric bush is embodied as stepped so that it has a larger diameter at its end oriented toward a mounting flange than it does at its opposite end.

Alternatively, it is also possible to eliminate the use of an eccentric bush and to adjust the axial distance between the worm axis and the worm gear axis by a measurement of the tolerance position of the preinstalled motor and a correspondingly aligned drilling of the receiving bore for the bearing bush, e.g. on the assembly line. The disadvantages of this are that the measurement and drilling must be executed when the motor has already been preinstalled, that it is not possible to reliably prevent shavings from remaining in the motor, and that a washing after the drilling is not possible. It is also not possible to check for shavings remaining in the motor or to take remedial action, as a result of which, failures can occur during operation.

The current invention has the advantage that a drive unit is produced in which the axial distance between the armature shaft and the driven shaft can be reliably adjusted. The electrical drive unit according to the invention is distinguished in that two eccentric bushes are installed spaced apart from each other in the transmission housing in order to support the driven shaft. This avoids the known disadvantages of the prior art. Particularly in bearings that should be longer than approx. 40 mm, the axial distance can be achieved for an optimal cost and in a simple way. Both the bush itself and the bearing seat are designs that, from a production engineering standpoint, are simpler than the known prior art. The effective bearing length with regard to strain capacity and long-running properties is determined according to the invention by the sums of the two lengths of the bushes and their distance from each other. These bearing properties can be adjusted within a broad range when short eccentric bushes are used in pairs.

From a production engineering and technical assembly standpoint, it is particularly simple if the two eccentric bushes are embodied as identical.

According to a preferred embodiment form, positioning means of the two eccentric bushes used are disposed at exactly the same location on the circumference in terms of the eccentricity in order to be able to assure the axial distance by means of the matched rotation of the two bushes quickly, simply, and in an absolutely tilt-free way. This is particularly assured if the positioning means simultaneously serve as engagement surfaces and edges for a suitable assembly tool for rotating the eccentric bushes.

Two exemplary embodiments of the drive unit bearing bush according to the invention are described below.

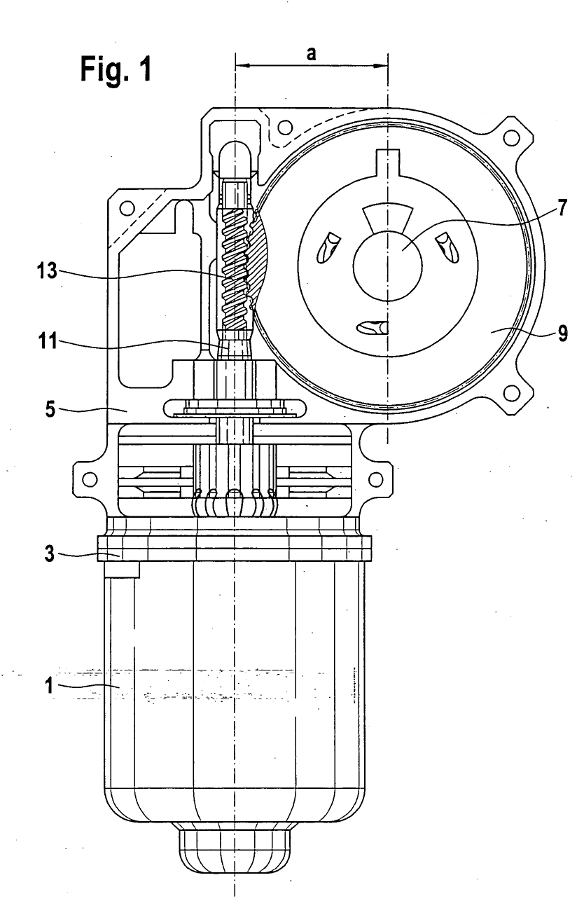

FIG. 1 is a top view of drive unit according to the invention, with the transmission cover removed,

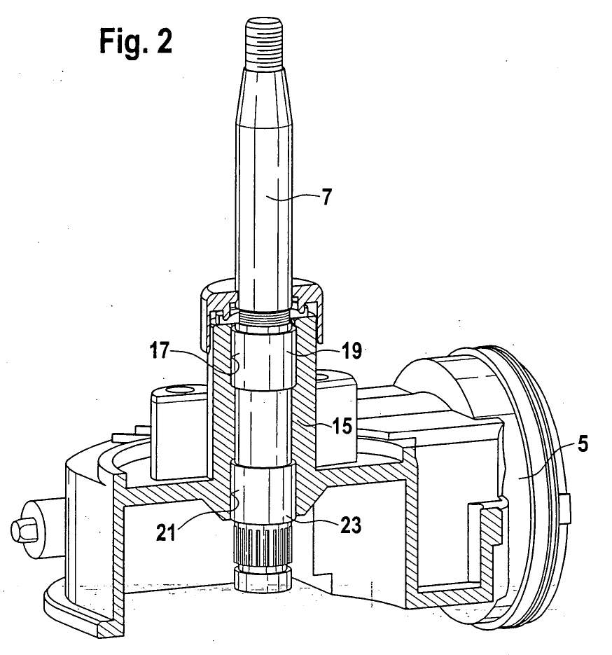

FIG. 2 is a perspective view of a detail of the drive unit,

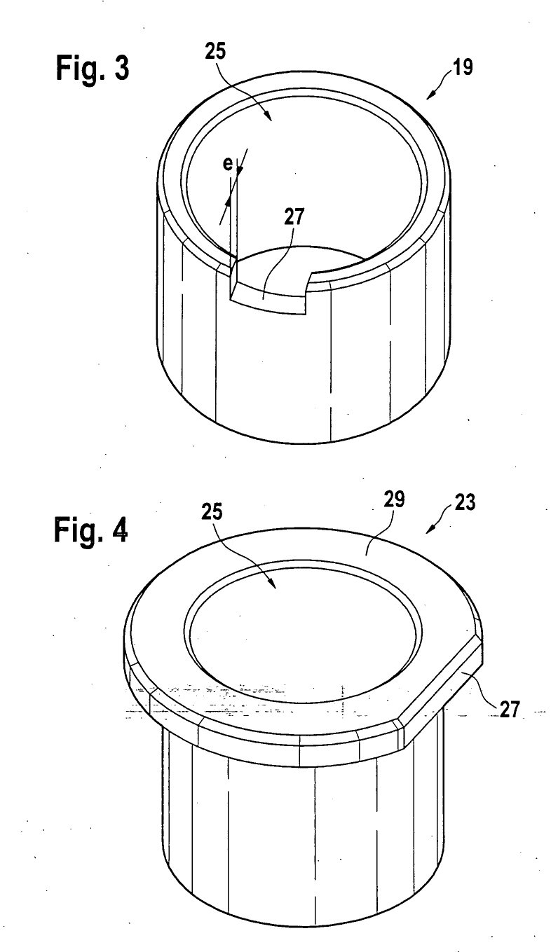

FIG. 3 shows an enlarged scale perspective view of an eccentric bearing bush according to a first exemplary embodiment, and

FIG. 4 shows an enlarged scale perspective view of an eccentric bearing bush according to a second exemplary embodiment.

An electrical drive unit that is for windshield wipers of a motor vehicle and is shown in FIGS. 1 and 2 includes an essentially cup-shaped pole housing 1 that contains an armature. A transmission housing 5 that is made of die cast aluminum, for example, and is likewise essentially cup-shaped is fastened on its end to a flange 3 of the pole housing 1. The transmission housing 5 contains a worm gear 9 that is attached to a driven shaft 7 and engages with a worm 13 connected to an armature shaft 11 of the armature (FIG. 1). The worm gear pair thus formed permits the speeds and torques required in a wiper motor. The transmission housing 5 has a bearing tower 15 with a first bearing seat 17 for an upper bearing bush 19 and a second bearing seat 21 for a lower bearing bush 23 (FIG. 2).

In order to be able to adjust an exact axial distance a between the armature shaft 11 and therefore the worm 13 and of the driven shaft 7 and therefore the worm gear 9, the bearing bushes 19, 23 are embodied as eccentric bushes that have an identical eccentricity e. Inner bores 25 or cylindrical inner surfaces of the eccentric bushes 19, 23 are eccentrically disposed, with the eccentricity e. The bearing bushes 19, 23 mounted in the drive unit can be embodied as identical pairs or can also be embodied as pairs with certain different features. The bearing bushes 19, 23 each have a positioning means 27 that allows the bushes in the bearing seats 17, 21 to be aligned exactly in relation to each other in terms of their rotational positions. The positioning means 27 are disposed at exactly the same location on the circumference in terms of the eccentricity e. In addition, the positioning means 27 are embodied so that they simultaneously serve as engagement surfaces and edges for an assembly tool for exactly rotating the eccentric bushes 19, 23. The bearing bush according to FIG. 4 also has a collar 29, which on the one hand, serves as a stop during assembly and on the other hand, serves as a contact surface for an external washer (not shown). Because of the eccentricity e of the bearing bushes 19, 23, the axial distance a can be adjusted by rotating the bearing bushes 19, 23 in the bearing tower 15. The axial distance a is adjusted here by measuring the preinstalled motor, appropriate rotation of the bearing bushes into the appropriate positions in their respective bearing seats 17, 21. As soon as the corrected desired axial distance a has been achieved, the two eccentric bushes 19, 23 are then fastened in the bearing tower 15, e.g. by being press-fitted in place. A suitable matching of the bearing seat and bush tolerances assures that the two eccentric bushes cannot rotate undesirably in their bearing seats during operation.

The division of the bearing in two, the simpler geometry, and the resulting shorter design of the bearing bushes also makes it possible to achieve bearing lengths of greater than 40 mm simply by means of the eccentric principle. The design can be used for wiper drive units or for other types of drive units.

1. An electric drive unit, in particular for windshield wipers of a motor vehicle, with a drive motor that has a transmission housing (5) for containing at least one worm gear (9) that is supported on a driven shaft (7) and engages with a worm (13) connected to an armature shaft (11) of the drive motor, which driven shaft (7) is supported in an eccentric bush that can be rotated in order to adjust an axial distance (a) between the armature shaft (11) and the driven shaft (7) and can be mounted in the rotated position so that it is prevented from rotating in the transmission housing (5), characterized in that two eccentric bushes (19, 23) are mounted spaced apart from each other in the transmission housing (5) in order to support the driven shaft (7).

2. The drive unit according to claim 1, characterized in that the two eccentric bushes (19; 23) are identically embodied.

3. The drive unit according to claim 1, characterized in that the two eccentric bushes (19; 23) have the same eccentricity (e).

4. The drive unit according to claim 1, characterized in that positioning means (27) are provided on both of the eccentric bushes (19; 23).

5. The drive unit according to claim 4, characterized in that the positioning means (27) are disposed at exactly the same location on the circumference in terms of the eccentricity (e).

6. The drive unit according to claim 4, characterized in that the positioning means (27) simultaneously serve as engagement surfaces and edges for an assembly tool for rotating the eccentric bushes.

7. A method for assembly of an electrical drive unit with a transmission housing (5) for containing at least one worm gear (9) that is supported on a driven shaft (7) and engages with a worm (13) connected to an armature shaft (11) of the drive motor, which driven shaft (7) is supported in an eccentric bush, characterized in that two eccentric bushes (19, 23) spaced apart from each other serve to support the driven shaft and are brought into the correct rotational position and then fastened to prevent them from rotating in the transmission housing (5) in order to adjust an axial distance (a) between the armature shaft (11) and the driven shaft (7).
